(19) United States
(12) Patent Application Publication
(10) Pub. No.: US 2003/0151832 A1
(43) Pub. Date: Aug. 14, 2003

(54) Method and apparatus for enclosing optical assemblies

(76) Inventors: Arthur Berman, San Jose, CA (US); Michael Detro, Los Gatos, CA (US)

Correspondence Address: Crosby, Heafey, Roach & May, P.O. Box 7936, San Francisco, CA, 94120-7936, US

(21) Appl. No.: 10/328,423

(22) Filed: Dec. 24, 2002

Related U.S. Application Data
(60) Provisional application No. 60/348,755, filed on Jan. 14, 2002.

(51) Int. Cl. G02B 5/04; G02B 7/18

(52) U.S. Cl. 359/831

(57) ABSTRACT

A frame is used to form a liquid tight seal between optical components such as beam splitters in a prism assembly suitable for use in a kernel. The frame covers channels and intersections of channels between the optical components. A sealant, such as an adhesive or gasket material is placed between the frame and the optical components to create the seal. Many different configurations of optical components may be held together in an assembly using the frame. In one embodiment, the optical components are pathlength matched beam splitters arranged in pathlength matched positions of a prism assembly suitable for use in a kernel. In one embodiment, the frame includes a central plate and a bottom portion, arms, and one or more interlocking mechanisms to hold the frame around the optical components.

### CLAIM OF PRIORITY

This invention claims priority to the following co-pending U.S. provisional patent application, which is incorporated herein by reference, in its entirety:

Arthur Berman et al., Provisional Application Serial No. 60/348,755, entitled “ENCLOSURES FOR USE IN LIQUID COUPLED OPTICAL ASSEMBLIES,” attorney docket no. 26508.00300, filed, Jan. 14, 2002.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of Invention

The present invention relates to enclosures for optical assemblies. The present invention is more particularly related to liquid tight enclosures for holding prism assemblies having liquid coupled interfaces between optical components of the prism assembly.

2. Discussion of Background

LightMaster Systems, Inc. has developed a variety of configurations for optical assemblies (e.g., prism assemblies) used in reflective microdisplay based video projectors (light engines). LightMaster Systems, Inc. has developed liquid coupling techniques that are applicable to many different types of optical devices. However, the use of liquid coupling presents additional requirements on the design and construction of optical devices.

### SUMMARY OF THE INVENTION

The present inventors have realized the need to provide enclosures for optical assemblies. In addition, the present inventors have realized the need to contain liquid within an optical assembly and to hold optical components of the assembly in place in space (registration).

An example liquid coupled optical device is described in Detro et al, U.S. patent application Ser. No. 60/322,490 entitled “Method and Apparatus for Configuration and Assembly of a Video Projection Light Management System” filed Sep. 12, 2001, the contents of which are incorporated herein by reference in their entirety. The optical device described is a liquid coupled prism assembly, liquid coupled meaning that an index matching fluid (or optical coupling fluid) resides in the optical path between at least two components of the prism assembly.

Detro et al. addresses these additional requirements by describing a “frame” glued to the outside of the prism so as to form an enclosure. The frame is made of a material with a coefficient of thermal expansion similar to that of the glass within the prism. (In fact, one possibility is that the frame be made of the same type glass.) In Detro et al., some frame elements were illustrated as separate pieces applied individually to each external liquid filled “joint”. Although this approach will surely accomplish the functions of containment and registration the method is not well suited for high volume prism assembly. The reason is the time and labor-consuming process required to individually and sequentially apply each of the several frame elements to the prism.

Thus, the present inventors have determined a means of enclosure (that is, types of frame and methods of frame application) that is suited to high volume assembly of liquid coupled prisms. In the context of prism assemblies, better suited means methods that require less parts and labor and that are, consequentially, less expensive, but not necessarily an improvement or equal in registration or other qualities of the prism assembly. In one embodiment, the present invention provides a frame configured to comprise at least part of a liquid tight seal around a set of optical components. The frame may be constructed from a single piece of material or from multiple separate pieces coupled together. The pieces may be coupled together using a variety of mechanisms including any of adhesive, interlocking arms, etc. The optical components form, for example, a pathlength matched prism assembly.

The invention includes a method comprising the step of, sealing a set of optical components with a frame forming a liquid tight enclosure around an area between at least two of the optical components. The step of sealing comprises, for example, applying an adhesive between the frame and at least part of at least one of the optical components. And, the optical components comprises, for example, a prism assembly suitable for use in a kernel of a video projection system.

In yet another embodiment, the present invention is a prism assembly, comprising, a set of optical components, a frame coupled to at least one part of each of the optical components, and a sealant placed between the frame and at least one of the optical components so as to form a liquid tight seal between the frame and optical components.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a drawing of a prism enclosure 100 according to an embodiment of the present invention;

FIG. 2 is a perspective drawing of a prism, a folded frame according to an embodiment of the present invention, and the frame applied to the prism; and

FIG. 3A is a top view of a prism assembly;

FIG. 3B is a top view of a prism enclosure according to the present invention enclosing a prism assembly;

FIG. 3C is a bottom view of a prism enclosure according to the present invention enclosing a prism assembly;

FIG. 4 is a flow chart illustrating an example of a prism assembly process according to an embodiment of the present invention; and

FIG. 5 is a drawing of a two part frame according to an embodiment of the present invention.

### DESCRIPTION OF THE PREFERRED EMBODIMENTS

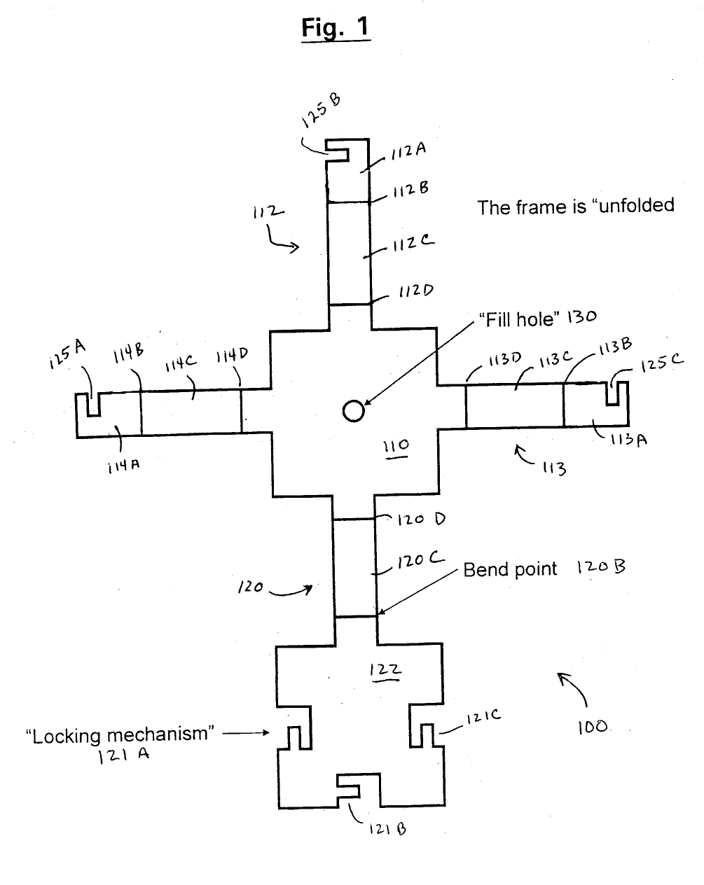

Referring now to the drawings, wherein like reference numerals designate identical or corresponding parts, and more particularly to FIG. 1 thereof, there is illustrated a drawing of a prism enclosure 100 according to an embodiment of the present invention.

A frame 100 utilized in the first new configuration is illustrated in FIG. 1. As shown, the frame 100 is a flat, single piece of material that consists of a series of connected segments (e.g., segments 112A, 112C, 113A, 113C, etc.). The frame 100 can be formed by stamping or molding. Points at which the frame 100 is intended to bend (around a prism assembly) are “scored” to facilitate the fold (e.g., segments 112A and 112C are separated by score 112B).

Although not strictly required, the frame illustrated in FIG. 1 includes generic “locking mechanisms” (e.g., 125A, 125B, 125C) at the ends of three of the “arms” (112, 112, 114). Their purpose is to provide a means for the frame to lock into place further simplifying attachment to the prism assembly.

Application of the frame is performed by gluing to the prism assembly with an adhesive. It is possible to use a two-part or thermally cured adhesive for this purpose. Another possibility is to use a UV curable adhesive. In the later case, it is desirable that the frame material be at least partially transmissive to UV light. The glue can be applied to the frame (or prism assembly) in several ways. First, a line of glue can be spread onto the prism assembly and then the frame applied. Second, the frame can be applied as the first step and then the glue dispensed along the edges of the frame. The adhesive will spread under the frame by capillary action. In some configurations it may be desirable to “perforate” the frame and apply the glue in the perforations. This will assist capillary action in assuring that the glue completely fills the surface between the frame and the prism.

Note that there is a small hole (fill hole 130) in the center of a central plate 110 of the frame. It is a fill hole that roughly corresponds to the fill hole described in the previous patent applications (see Detro et al.). One of the purposes of the enclosure is to contain fluid between optical components of an optical assembly. The optical assembly is, for example, a prism assembly, comprising polarizing beamsplitters, waveplates and/or other components. The optical components include at least one interface that is liquid coupled, the liquid being held at the interface of the optical components, at least in part, based on the enclosure (e.g., frame 100). In the embodiment of FIG. 1, the enclosure is a frame bent into a shape that conforms to at least part of the optical assembly. Channels are formed between the optical components (at the interface of the optical components) which are filled with an optical coupling fluid. In this embodiment, the frame conforms to each of the channels and helps provide a liquid tight enclosure around the optical assembly. The fill hole 130 provides a place for the optical coupling fluid to be inserted into the channels through the enclosure. In other embodiments, a fill tube or other mechanism that allows insertion of the fluid is utilized.

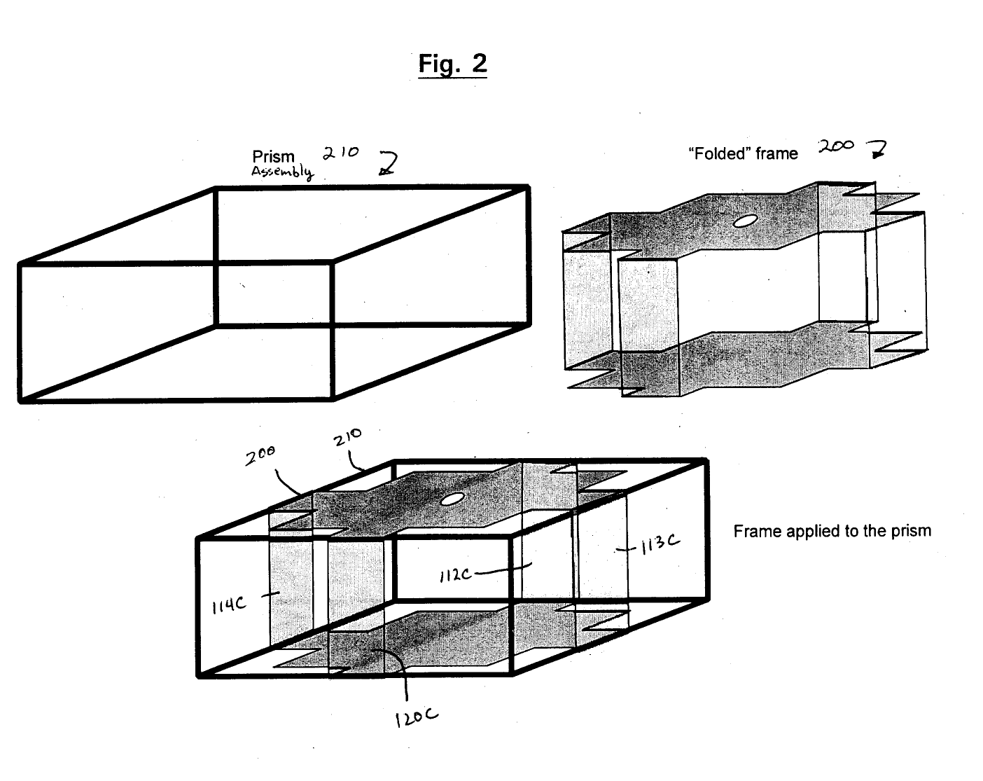

FIG. 2 is a perspective drawing of a folded frame 200 and a prism assembly 210 according to an embodiment of the present invention. The prism assembly 210 is, for example, a set of polarizing beam splitters or other optical components arranged in a rectangular box-like shape. The frame 100 has been folded to produce the folded frame 200. Folded frame 200 provides an enclosure in which the prism assembly 210 is inserted. The top portion 110, bottom portion 122, and arms 112C, 113C, 114C, and 120C each cover and help seal an area in which liquid is to be enclosed. If the frame is formed to close enough tolerances, the frame may by itself provide adequate sealing, but preferably, at least a small amount of adhesive (or a gasket) is applied to portions of the frame contacting optical components of the prism assembly 210. The combined frame and adhesive (or gasket) provide a liquid tight seal. In another embodiment, a larger amount of adhesive is applied to the outside parts of the channels between optical components and the frame mainly performs the function of holding the adhesive in place until cured, the adhesive then providing the entire seal.

FIG. 2 illustrates the frame applied to the prism. Note that the locations of all external liquid joints are covered by the frame. The liquid will be fully contained. When the frame has been glued to the prism components it will also serve to rigidly hold all optical components in place.

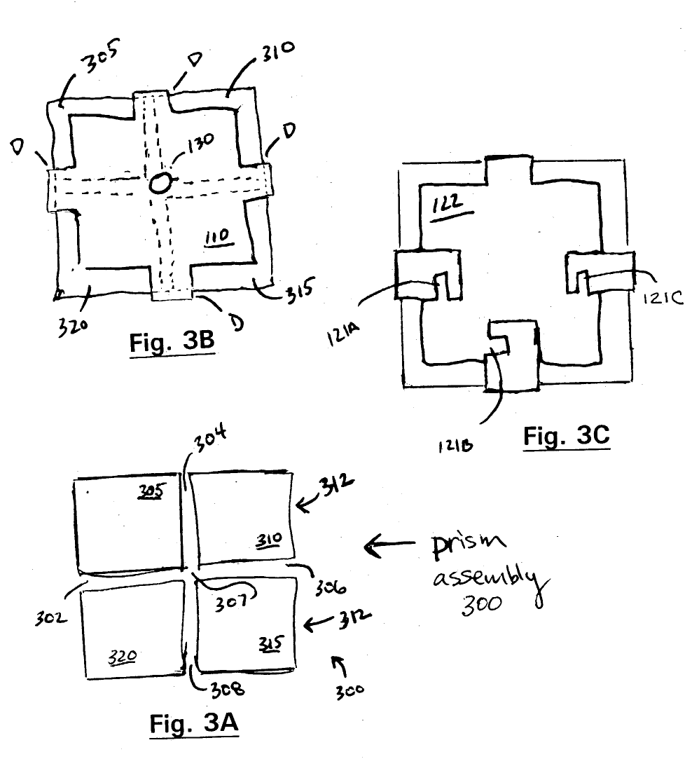

FIG. 3A is a top view of a prism assembly 300, including optical components 305, 310, 315, and 320. The optical components are, for example, beam splitters that function according to, for example, beam splitters described in U.S. Patent Applications, Detro, U.S. patent application Ser. No. 10/251,225 entitled “Pathlength Matched Beam Splitter and Method and Apparatus for Assembly,” filed Sep. 20, 2002, the contents of which are incorporated herein by reference in their entirety. The beam splitters according to Detro, are designed to be pathlength matched (e.g., light paths through the beam splitters are optically matched). Beam splitters of different designs and/or other optical components may be used to make the prism assembly 300. The various optical components of the prism assembly 300 are to be coupled via a liquid placed between the optical components (beam splitters in this example).

FIG. 3B is a top view of a prism enclosure (or frame) 100 according to the present invention enclosing the prism assembly 300. The central plate 110, arms D (112, 113, 114, and 120), and a bottom portion 122 fully cover each of channels 302, 304, 306, and 308 between each of the optical components and a middle area at the conjunction (intersection) of each channel (e.g., as illustrated in FIG. 3B, below the fill hole 130).

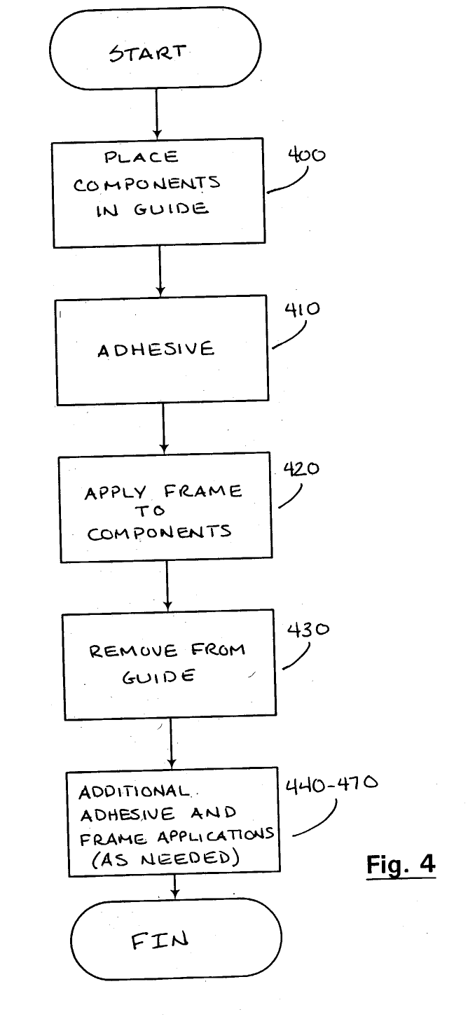

The enclosure and optical components may be assembled utilizing various methods. FIG. 4 is a flow chart illustrating an example of an assembly process according to an embodiment of the present invention. At step 400, the optical components are set in a precision holding device that holds the optical components (maintains registration of the prism assembly) in pathlength matched positions. Adhesive is placed on the top of the frame and arms (step 410), and the arms are bent around the sides of the optical components (e.g., side 312) (step 420). After the adhesive sets, the components and attached frame are removed from the precision guides (now held in registration by the adhesive on the top and arms of the frame) (step 430). Additional adhesive is applied to arm 120 and a bottom part of the frame 100 (step 440), and the arm 120 and bottom part are bent around until the bottom part covers a bottom opening of the channels (step 450). The other arms 112, 113, and 114 also have adhesive applied and they are bent around remaining portion of their corresponding channels between the optical components (step 460) and interlocked (step 470) to the bottom portion 122. Adhesive is applied at all parts of the arms and other parts of the frame to insure a water tight seal around the prism assembly. Variations of this example process will be evident to the ordinarily skilled artisan based upon review of the present disclosure (e.g., first fitting the frame and then using capillary action to apply the adhesive). Although the frame is illustrated as a single piece of material (e.g. plastic, steel), the frame may be composed a separate parts (e.g., glass, plastic, steel) held together via adhesive, interlocking frame members, and/or other attachment mechanisms etc.

FIG. 3C is a bottom view of a prism enclosure according to the present invention enclosing a prism assembly. The bottom portion 122 is shown in detail. Each arm is wrapped around the prism assembly 300 and each of cut out channels 125A, 125B, and 125C are interlocked with a corresponding one of the locking mechanisms 121A, 121B, and 121C. However, any type of style of interlocking latches or fittings may be utilized.

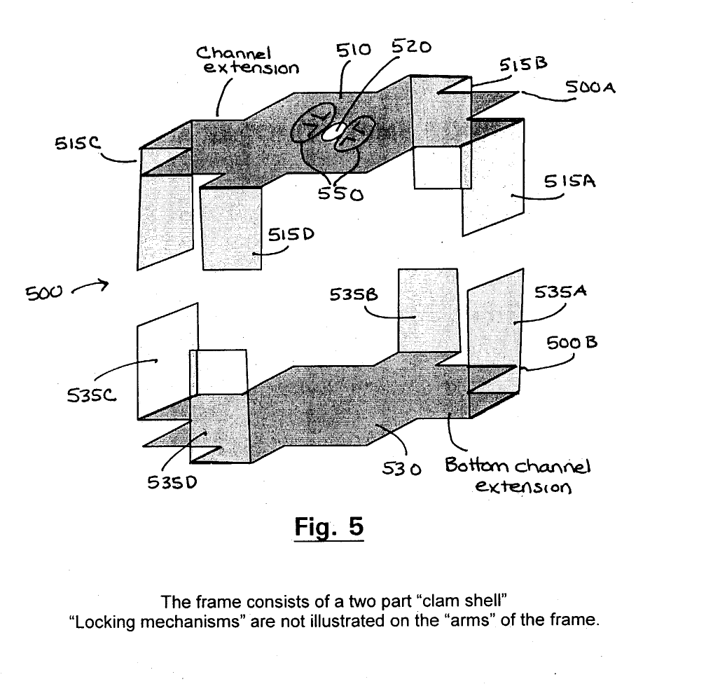

FIG. 5 is a drawing of a two part frame 500 according to an embodiment of the present invention. The two part frame 500 includes a top part 500A and a bottom part 500B. The top part 500A includes a main area 510 configured to cover part of the channels and an intersection of the channels of the prism assembly and/or other optics enclosed by the frame (e.g., channels 302, 304, 306, and 308, and intersection 307). The main area 510 includes a fill hole 520 that provides access for liquid filling the channels and intersection. Arms 515 A, 515B, 515C, and 515D extend downward from channel extensions off the main area 510. The arms and channel extensions are positioned so as to fully cover the channels (or other gaps between optical components).

The bottom part 500B includes a bottom main area 530 configured to cover channels and the intersection of the channels along a bottom portion of the prism assembly. Matching arms 535A, 535B, 535C, and 535D each extend upward to one of the arms 515 along a corresponding channel of the prism assembly. The two part frame is assembled by placing optical components (e.g., prisms, beam splitters, and other optics) inside either the top part 500A or bottom part 500B, and then fitting the other (top or bottom) part. In one embodiment, the optical components are be set in fixed positions (e.g., pathlength matched positions), prior to being placed in and secured by the frame. In another embodiment, the frame is precision constructed and the arms provide for precise fitting of the optical components. Precise fitting of the optical components may be enhanced with the inclusion of precision stops 550. The precision stops 550 provide a corner piece for fitting beam splitters (or another optical component) onto the frame 500 in an appropriate position (e.g., pathlength matched position within a prism assembly). FIG. 5 illustrates a set of 4 stops 550, one for each of 4 beam splitters, however, additional stops (e.g., one for each corner of each beam splitter) may be provided.

As noted above, the optical components may be placed in pathlength matched positions. For example, Detro et al., U.S. patent aplication Ser. No. 60/322,490, discussed above and incorporated herein by reference in its entirety, describes a prism assemblies where pathlengths of light through the prism assemblies are optically matched, and are referred to as pathlength matched prism assemblies (e.g., in a configuration suitable for use in a kernel). The prism assemblies of Detro et al. may be utilized in the embodiments described herein. Furthermore, Detro et al also describes optical elements that may be placed between various of the optical components of a prism assembly (e.g., waveplates placed between adjacent beam splitters of the pathlength matched prism assembly). The frames of the present invention are conveniently applied to pathlength matched prism assemblies, and include various embodiments having optical elements such as waveplates (quarter waveplates, half waveplates, etc.), filters (color filters, polarizers, etc) placed between adjacent optical components (e.g., pathlength matched polarizing beam splitters, prisms, higher order waveplates, etc).

In one embodiment, the optical components are pathlength matched beam splitters arranged in pathlength matched positions in a prism assembly suitable for use in a kernel of a video projection system. Any one or more combinations of the above described components, elements, and configurations may be utilized and not depart from the scope and intent of the present invention.

In the embodiment illustrated in FIG. 5, each of the matching arms 535 are configured to fit outside a corresponding one of arms 515. The arms and matching arms each include one or more locking mechanisms (e.g. interlocking mechanisms, snaps, etc.) (not shown) to connect the arms in a tightly fit package.

During assembly, the main area 510, arms 515, matching arms 535, and bottom main area 530 have a sealant applied so as to create a liquid tight seal between the, optical components of the prism assembly and the frame. The sealant may be, for example, is a gasket material, adhesive (e.g., UV curable adhesive), etc. The combination of the frame, optical components, and adhesive creating a liquid tight seal for each of the channels and intersection of the channels, with an opening at the fill hole 520. In one embodiment, adhesive is applied over the channels (e.g., between the optical components), creating an adhesive seal (or enhancing a the seal between the frame and optical components), with the frame helping to hold the adhesive in place during curing. When cured, the frame and adhesive together form the seal and an enclosure for the prism assembly, the adhesive performing mainly as the seal, and the frame, having held the adhesive in place during curing, now performs mainly as an enclosure. The frame may include, for example, hooks, hinges, tracks, or other devices used to fit the prism assembly into a light engine or other optical device.

Obviously, numerous modifications and variations of the present invention are-possible in light of the above teachings. It is therefore to be understood that within the scope of the appended claims, the invention may be practiced otherwise than as specifically described herein.

What is claimed and desired to be secured by Letters Patent of the United States is:

1. A frame configured to comprise at least part of a liquid tight seal around a set of optical components.

2. The frame according to claim 1, wherein said frame comprises a series of frame elements each configured to be positioned over at least one of a channel and an intersection of channels between the set of optical components.

3. The frame according to claim 2, wherein said frame elements are secured to at least two of the optical components so as to form the liquid tight seal between the optical components.

4. The frame according to claim 1, wherein:
said frame is configured to hold an adhesive in place; and
the adhesive, when cured, forms a liquid tight seal between at least two of the optical components.

5. The frame according to claim 2, wherein said frame elements include a top, a bottom, and at least one arm connecting the top and bottom.

6. The frame according to claim 5, wherein:
said top and bottom are configured to cover top and bottom portions of the intersection of channels between the optical components; and
said at least one arm is configured to cover at least part of at least one of the channels.

7. The frame according to claim 5, wherein said frame is constructed from a flat material scored at positions where the flat material is shaped so that said top and bottom pieces and said at least one arm are positioned around the optical components along the channels and the intersection of the channels.

8. The frame according to claim 2, further comprising adhesive placed on said frame elements so as to create a liquid tight seal in said channels and intersection.

9. The frame according to claim 2, wherein said frame elements comprise at least two frame elements having interlocking mechanisms configured to hold the frame elements in a predetermined position.

10. The frame according to claim 9, wherein said predetermined position is around the set of optical components in a prism assembly.

11. The frame according to claim 10, wherein said prism assembly is part of a kernel in a video projection system.

12. The frame according to claim 2, wherein said frame elements comprise two separate pieces of material each configured to be coupled with at least part of the set of optical components at different positions and form an enclosure around at least part of at least two of the set of optical components.

13. The frame according to claim 3, wherein the separate pieces of material comprise a top piece with arms extending downward, and a bottom piece with matching arms extending upward.

14. The frame according to claim 4, wherein at least one of said pieces includes a fill hole.

15. A method comprising the step of:
sealing a set of optical components with a frame forming a liquid tight enclosure around an area between at least two of the optical components.

16. The method according to claim 15, wherein said optical components comprise a prism assembly.

17. The method according to claim 15, wherein said optical components comprise a pathlength matched prism assembly.

18. The method according to claim 15, wherein said step of sealing comprises applying an adhesive between the frame and at least part of at least one of the optical components.

19. The method according to claim 15, wherein said step of sealing comprises applying adhesive between at least part of said frame and at least two of the optical components.

20. The method according to claim 15, further comprising the step of:
filling the liquid tight enclosure with an optical coupling fluid.

21. The method according to claim 20, wherein the optical coupling fluid has an index of refraction closely matching an average index of refraction of the optical components.

22. The method according wherein said optical components are arranged in pathlength matched positions.

23. The method according to claim 15, wherein said frame includes stops that fix at least two of the optical components in pathlength matched positions.

24. The method according to claim 15, wherein said step of sealing comprises the steps of:
setting the set of optical components in a holding device;
applying adhesive to the frame;
bending at least part of the frame around sides of the optical components;
interlocking at least two parts of the frame to secure the frame around the optical components;
wherein the frame is configured so as to fit around the optical components and the frame in combination with the adhesive seals channels between the optical components.

25. The method according to claim 24, wherein said holding device maintains a registration of the optical components in pathlength matched positions.

26. The method according to claim 15, wherein said frame comprises two interlocking parts.

27. The method according to claim 15, wherein at least one of the interlocking parts includes at least one of precision placed arms and precision placed stops configured to place at least two of the optical components in pathlength matched positions.

28. A prism assembly, comprising:
a set of optical components;
a frame coupled to at least one part of each of the optical components;
a sealant placed between the frame and at least one of the optical components so as to form a liquid tight seal between the frame and optical components.

29. The prism assembly of claim 28, wherein said sealant is a gasket.

30. The prism assembly of claim 28, wherein said sealant is an adhesive.

31. The prism assembly according to claim 28, further comprising a fill hole in the frame.

32. The prism assembly according to claim 28, further comprising at least one optical element placed between two of the optical components.

33. The prism assembly according to claim 32, wherein said at least one optical component comprises a waveplate.

34. The prism assembly according to claim 28, wherein the optical components comprise a set of pathlength matched polarizing beamsplitters arranged in a prism assembly suitable for use in a kernel.

35. The prism assembly according to claim 34, wherein the beamsplitters are fixed in pathlength matched positions in the prism assembly.

36. The prism assembly according to claim 32, further comprising spacers positioned between at least one of the optical elements and one of the optical components.

37. The prism assembly according to claim 28, wherein said optical components comprise at least one beam splitter.

38. The prism assembly according to claim 28, further comprising index matching fluid placed between the optical components and held in place by the liquid tight seal.

39. The prism assembly according to claim 28, wherein said optical components are arranged in a prism assembly suitable for use in a kernel.

40. The prism assembly according to claim 28, wherein said optical components are arranged in a pathlength matched prism assembly.

41. The prism assembly according to claim 40, further comprising at least one of precision placed stops and precision placed frame appendages that fit the optical components into pathlength matched positions.

42. The prism assembly according to claim 28, wherein said frame is a two part frame fitted together to enclose at least part of each optical component.

43. The prism assembly according to claim 28, wherein said frame is a single piece of material having top and bottom portions and arms placed around the optical components to substantially create the liquid tight seal.

44. The prism assembly according to claim 43, wherein at least one of the arms and portions are configured to interlock with at least one other of the arms and portions.
